(19) United States
(12) Patent Application Publication
(10) Pub. No.: US 2025/0298964 A1
(43) Pub. Date: Sep. 25, 2025

(54) METHOD AND SYSTEM FOR AUTOMATICALLY CREATING CONTENTS

(71) Applicant: SAMSUNG SDS CO., LTD., Seoul (KR)

(72) Inventors: Ji Yeon LEE, Seoul (KR); Young Hyun CHOI, Seoul (KR); Seung Jin KIM, Seoul (KR)

(73) Assignee: SAMSUNG SDS CO., LTD., Seoul (KR)

(21) Appl. No.: 19/070,077

(22) Filed: Mar. 4, 2025

(30) Foreign Application Priority Data
Mar. 19, 2024 (KR) 10-2024-0037621
May 23, 2024 (KR) 10-2024-0067159

(51) Int. Cl. G06F 40/166; G06F 3/0482; G06F 40/35; G06F 40/40; G06T 11/20; G06T 11/60; G06T 13/20; G06T 13/40; G06T 13/80

(52) U.S. Cl. CPC G06F 40/166; G06F 3/0482; G06F 40/35; G06F 40/40; G06T 11/206; G06T 11/60; G06T 13/205; G06T 13/40; G06T 13/80

(57) ABSTRACT

A method and system for creating contents automatically is provided. A computer program 1500 according to an embodiment may include instructions for performing steps of acquiring semantic information on a contents set composed of a plurality of contents, and inputting a prompt automatically created using the semantic information on the contents set and at least some of the plurality of contents into the large multi-modal model to acquire output contents related to the plurality of contents.

### CROSS-REFERENCE TO RELATED APPLICATIONS

This application claims priority from Korean Patent Application Nos. 10-2024-0037621 filed on Mar. 19, 2024 and 10-2024-0067159 filed on May 23, 2024 in the Korean Intellectual Property Office, and all the benefits accruing therefrom under 35 U.S.C. 119, the contents of which in its entirety are herein incorporated by reference.

### BACKGROUND

### Field

The present disclosure relates to a method for automatically creating contents and a system to which the method is applied. More specifically, the present disclosure relates to a method for automatically creating a specific type of contents using a plurality of content files and a system to which the method is applied.

### Description of Related Art

FIG. 1 is an example diagram illustrating a step that a worker should perform in order to create a specific output in a conventional work environment. Since the worker should first grasp the content of each of the plurality of files, the worker should grasp the meaning of the contents included in the plurality of files as many as the number of files. Further, based on the result of identifying the content of each of the plurality of files, unnecessary files are excluded and meaningful files are arranged in a chronological order.

Next, in order to create new contents, the worker arranges the files to be referred to in the order of the table of contents of the new contents, and creates the new contents by referring to the arranged plurality of files. In the contents creation method as described above, it takes a considerable amount of time to grasp the meaning of the file regardless of whether it is difficult to understand the contents of the files prepared for the contents creation. Thus, there is a problem in that a time cost of a high-cost manpower is wasted.

In order to solve the above problem, a work division scheme in which a generative AI creates new contents has been attempted in the related art. However, parameters that the generative AI needs to input in order to create specific output contents are unclear. Thus, the related art scheme requires another manpower to create a prompt to be input to the generative AI.

Accordingly, a method of automatically creating a prompt for instructing the generative artificial intelligence (AI) to automatically create new contents based on a plurality of files has been required in the related art. However, automation of a method of creating a prompt corresponding to an output contents type is not provided due to technical difficulties.

### SUMMARY

A technical purpose to be achieved through some embodiments of the present disclosure is to provide a method of automatically identifying a type of output contents that can be created using an input contents set.

Another technical purpose to be achieved through some embodiments of the present disclosure is to provide a method of automatically creating a prompt for creating output contents using an input contents set.

Still another technical purpose to be achieved through some embodiments of the present disclosure is to provide a method of creating a user journey map using a plurality of images related to different screens displayed on a user terminal according to a UX design of a specific service.

Still yet another technical purpose to be achieved through some embodiments of the present disclosure is to provide a method for automatically creating a prompt that causes a large multi-modal model and a large language model to automatically create new contents on a set of contents.

The technical purposes of the present disclosure are not limited to the technical purposes mentioned above, and other technical purposes not mentioned may be clearly understood by those skilled in the art from the following description.

According to some embodiments of the present disclosure, an automatic contents creation system is provided. The system may comprise one or more processors, a memory storing therein a computer program executed by the one or more processors. The computer program may include instructions for: acquiring semantic information on a contents set composed of a plurality of contents and inputting a prompt automatically created using the semantic information on the contents set and at least some of the plurality of contents into a large multi-modal model to acquire output contents related to the plurality of contents.

In some embodiments, the acquiring of the output contents related to the plurality of contents may include selecting one of a plurality of output contents types as an output contents type of the output contents related to the plurality of contents, using the semantic information on the contents set, automatically creating a prompt corresponding to the selected output contents type and inputting the automatically created prompt and at least some of the plurality of contents into the large multi-modal model to acquire the output contents related to the plurality of contents.

In some embodiments, the output contents type may include a meeting minutes, a summary video, a user journey map, and a summary document.

In some embodiments, the automatically creating of the prompt corresponding to the selected output contents type may include selecting the prompt corresponding to the selected output contents type from a prompt library.

In some embodiments, the automatically creating of the prompt corresponding to the selected output contents type may further include automatically creating a first prompt and a second prompt corresponding to the selected output contents type when a number of the selected output contents types is at least two, calculating an uncertainty of a selection result of each of a first output contents type and a second output contents type included in the selected output contents types, determining a listing sequence of the first prompt and the second prompt, based on the uncertainty of the selection result of each of the first output contents type and the second output contents type and listing and displaying the first prompt and the second prompt in the determined listing sequence.

In some embodiments, the automatically creating of the prompt corresponding to the selected output contents type may further include receiving, from a user, a selection input of the first prompt in a list in which the first prompt and the second prompt are displayed, adjusting a recommendation score of the first prompt, identifying that output contents of the first output contents type and output contents of the second output contents type can be created using the second contents set, based on semantic information of a second contents set different from the contents set and automatically creating the first prompt when the semantic information of the second contents set and the semantic information of the contents set has a similarity greater than or equal to a reference value.

In some embodiments, the acquiring of the semantic information on the contents set composed of the plurality of contents may include inputting the contents set into the large multi-modal model to acquire the semantic information on the contents set.

In some embodiments, the acquiring of the output contents related to the plurality of contents may include inputting the prompt and at least some of the plurality of contents into the large multi-modal model to acquire semantic information on each of the input plurality of contents, inputting the semantic information on each of the input plurality of contents to a large language model, and acquiring an output of the large language model and inputting the output of the large language model to the large multi-modal model to acquire the output contents related to the plurality of contents.

In some embodiments, the plurality of contents may be composed of a plurality of images related to different screens displayed on a user terminal according to a user experience (UX) design of a first service, the output contents related to the plurality of contents may be a journey map of the UX design.

In some embodiments, the acquiring of the output contents related to the plurality of contents may include inputting the plurality of contents and a third prompt created based on the plurality of contents to the large multi-modal model to acquire sequence information of each of the plurality of contents and semantic information of each of the plurality of contents, inputting the sequence information of each of the plurality of contents and the semantic information of each of the plurality of contents to the large language model to acquire user action information corresponding to each of the plurality of contents and inputting the user action information corresponding to each of the plurality of contents to the large multi-modal model to acquire the journey map of the UX design.

In some embodiments, the plurality of contents may be related to a first conversation record, the first conversation record may include an utterance of a first speaker and an utterance of a second speaker, the computer program may further include an instruction for creating a fourth prompt instructing to create a summary video of the plurality of contents using the plurality of contents, the fourth prompt may include instructions to instruct the large multi-modal model to: determine a topic of the first conversation record, based on the plurality of contents, extract the utterance of the first speaker corresponding to the topic of the first conversation record, create an avatar of the first speaker and display the avatar of the first speaker in a first region of a scene of a summary video of the plurality of contents in which a first utterance of the first speaker is represented and display contents related to the first utterance in a second region thereof.

According to some embodiments of the present disclosure, an automatic contents creation method performed by a computing system is provided. The method may comprise acquiring semantic information on a contents set composed of a plurality of contents and inputting a prompt automatically created using the semantic information on the contents set and at least some of the plurality of contents into a large multi-modal model to acquire output contents related to the plurality of contents.

In some embodiments, the acquiring of the output contents related to the plurality of contents may include selecting one of a plurality of output contents types as an output contents type of the output contents related to the plurality of contents, using the semantic information on the contents set, automatically creating a prompt corresponding to the selected output contents type and inputting the automatically created prompt and at least some of the plurality of contents into the large multi-modal model to acquire the output contents related to the plurality of contents.

In some embodiments, the acquiring of the semantic information on the contents set composed of the plurality of contents may include inputting the contents set into the large multi-modal model to acquire the semantic information on the contents set.

In some embodiments, the acquiring of the output contents related to the plurality of contents may include inputting the prompt and at least some of the plurality of contents into the large multi-modal model to acquire semantic information on each of the input plurality of contents, inputting the semantic information on each of the input plurality of contents to a large language model, and acquiring an output of the large language model and inputting the output of the large language model to the large multi-modal model to acquire the output contents related to the plurality of contents.

In some embodiments, the plurality of contents may be composed of a plurality of images related to different screens displayed on a user terminal according to a user experience (UX) design of a first service, the output contents related to the plurality of contents may be a journey map of the UX design.

In some embodiments, the acquiring of the output contents related to the plurality of contents may include inputting the plurality of contents and a third prompt created based on the plurality of contents to the large multi-modal model to acquire sequence information of each of the plurality of contents and semantic information of each of the plurality of contents, inputting the sequence information of each of the plurality of contents and the semantic information of each of the plurality of contents to the large language model to acquire user action information corresponding to each of the plurality of contents and inputting the user action information corresponding to each of the plurality of contents to the large multi-modal model to acquire the journey map of the UX design.

In some embodiments, the plurality of contents may be related to a first conversation record, the first conversation record may include an utterance of a first speaker and an utterance of a second speaker, the method may further comprise creating a fourth prompt instructing to create a summary video of the plurality of contents using the plurality of contents, the fourth prompt may include instructions to instruct the large multi-modal model to: determine a topic of the first conversation record, based on the plurality of contents, extract the utterance of the first speaker corresponding to the topic of the first conversation record, create an avatar of the first speaker and display the avatar of the first speaker in a first region of a scene of a summary video of the plurality of contents in which a first utterance of the first speaker is represented, display contents related to the first utterance in a second region thereof.

In some embodiments, the automatically creating of the prompt corresponding to the selected output contents type may include selecting the prompt corresponding to the selected output contents type from a prompt library.

In some embodiments, the automatically creating of the prompt corresponding to the selected output contents type further may include automatically creating a first prompt and a second prompt corresponding to the selected output contents type when a number of the selected output contents types is at least two, calculating an uncertainty of a selection result of each of a first output contents type and a second output contents type included in the selected output contents types, determining a listing sequence of the first prompt and the second prompt, based on the uncertainty of the selection result of each of the first output contents type and the second output contents type and listing and displaying the first prompt and the second prompt in the determined listing sequence.

Specific details of other embodiments are included in the detailed description and drawings.

### BRIEF DESCRIPTION OF DRAWINGS

The above and other aspects and features of the present disclosure will become more apparent by describing in detail embodiments thereof with reference to the attached drawings, in which:

FIG. 1 is an example diagram for illustrating a problem of a conventional work method for creating specific contents;

FIG. 2 illustrates an example environment to which an automatic contents creation system according to an embodiment of the disclosure may be applied;

FIG. 3 is an example diagram for illustrating an operation of a system for automatically creating contents according to some embodiments of the present disclosure;

FIG. 4 is a flowchart of a method for automatically creating contents according to another embodiment of the present disclosure;

FIG. 5 is an example diagram for illustrating a step of automatically creating a prompt corresponding to a determined output contents type, which may be performed in some embodiments of the present disclosure;

FIG. 6 is a flowchart for illustrating some steps described with reference to FIG. 4 in detail;

FIG. 7 is an example diagram for illustrating a step of listing a plurality of prompts corresponding to a first contents set, that may be performed in some embodiments of the present disclosure;

FIG. 8 is a flowchart for illustrating some steps described with reference to FIG. 4 in detail;

FIG. 9 is an example diagram for illustrating an operation of creating a prompt corresponding to a second contents set, which may be performed in some embodiments of the present disclosure;

FIG. 10 is a flowchart for illustrating some steps described with reference to FIG. 4 in detail;

FIG. 11 is an example diagram for illustrating a step of acquiring sequence information and semantic information of a first data set, which may be performed in some embodiments of the present disclosure;

FIG. 12 is an example diagram for illustrating a step of creating a user journey map corresponding to a first data set, which may be performed in some embodiments of the present disclosure;

FIG. 13 is a flowchart for illustrating some steps described with reference to FIG. 4 in detail;

FIG. 14 is an example diagram for illustrating a step of acquiring semantic information of a first conversation record and information on an utterance included in the first conversation record, which may be performed in some embodiments of the present disclosure;

FIG. 15 is an example diagram for illustrating a step of creating a summary video on a first conversation record, which may be performed in some embodiments of the present disclosure; and

FIG. 16 is a hardware configuration diagram of a computing system according to still another embodiment of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), may be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Prior to the description of various embodiments of the present disclosure, terms used in embodiments as set forth below will be clearly described.

In embodiments as set forth below, the ‘user journey map’ may refer to information acquired by visualizing the emotion information of the user, information on whether the user's needs are satisfied, and action information of the user corresponding to each of a plurality of accessible touch points in the UX design of a specific service. In addition, the user journey map may be used interchangeably with terms such as a ‘customer journey map’ in the technical field.

In embodiments as set forth below, a ‘contents set’ may refer to a file set or a data set input from a user to an automatic contents creation system according to an embodiment of the present disclosure. That is, the contents according to embodiments as set forth below may refer to a specific file. However, in some embodiments, the contents may refer to a link or information stored in a page corresponding to the link.

Further, the contents set may include a plurality of files of different formats. For example, the contents set may be a contents set in which audio files, video files, text files, and document files are mixed with each other.

In embodiments as set forth below, ‘semantic information’ may refer to information represented by contents of a specific file.

For example, the semantic information may include contents of text visually represented by a specific image file.

In one example, the semantic information may include information related to a motion of an object included in a specific image file or a specific video file.

In another example, the semantic information may include topic information of a file set related to specific contents. For example, when a file set composed of a voice record, a video record, and a text record related to a meeting of a specific project is input into a large multi-modal model (LMM), the model may determine the topic of the file set as a meeting of a specific project.

In still another example, the semantic information may include name information of an object included in a specific image file.

In still yet another example, the semantic information may include a summary result of a specific text file.

In still yet another example, the semantic information may include feature information of an object included in a specific image file. For example, the semantic information may include color information of clothes worn by a specific person photographed in a specific image.

In still yet another example, the semantic information may include information about contents uttered by a specific speaker of a specific audio file.

In still yet another example, the semantic information may include information about contents uttered by a specific person included in a specific video file.

In still yet another example, the semantic information may include information on a document topic of a specific document format file.

In still yet another example, the semantic information may include appearance frequency information of a subject photographed in a specific video file. For example, the semantic information may include information on a time when a first subject appears in the video and a time when a second subject appears in the video.

In still yet another example, the semantic information may include utterance time information of each of a plurality of speakers included in a specific audio file.

Referring to the above some examples, the semantic information according to some embodiments of the present disclosure means contents included in a specific file that may be represented in natural language. Thus, it may be understood that the semantic information is interpreted as not limiting. In addition, in embodiments as set forth below, ‘semantic text’ may refer to a text representing the semantic information in natural language.

Hereinafter, some embodiments of the present disclosure will be described with reference to the drawings.

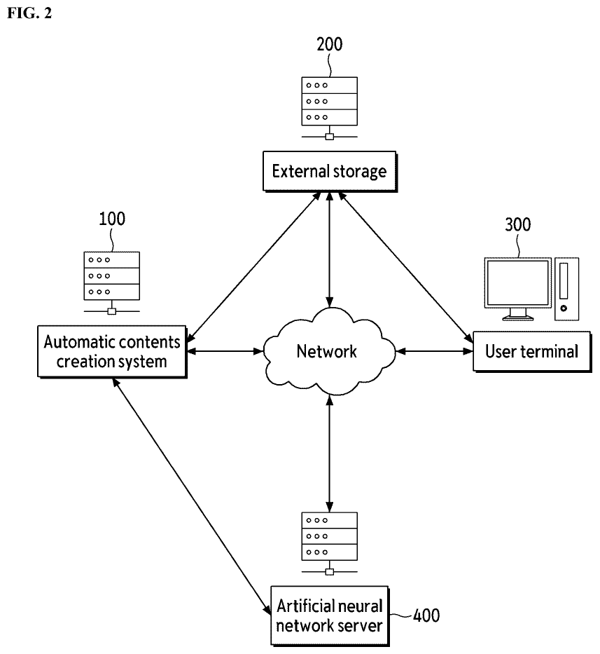

FIG. 2 illustrates an example environment to which an automatic contents creation system according to an embodiment of the disclosure may be applied.

Each of components illustrated in FIG. 2 may refer to software or hardware such as a field programmable gate array (FPGA) or an application-specific integrated circuit (ASIC). However, each of the components is not limited to software or hardware, and may be configured to be present in an addressable storage medium, or may be configured to execute one or more processors. A function provided in each of the components may be implemented by more subdivided components. Alternatively, a plurality of components may be combined with each other into one component that performs a specific function.

In some embodiments, an automatic contents creation system 100 may communicate with other components via a network. The network may be embodied as wired/wireless networks of all kinds, such as a Local Area Network (LAN), a Wide Area Network (WAN), a mobile radio communication network, and a wireless broadband Internet (WiBro).

An user terminal 300 may be a laptop, a desktop, a laptop, a smartphone, a tablet, or the like. However, the present disclosure is not limited thereto, and the user terminal 300 may include all types of devices equipped with a computing function.

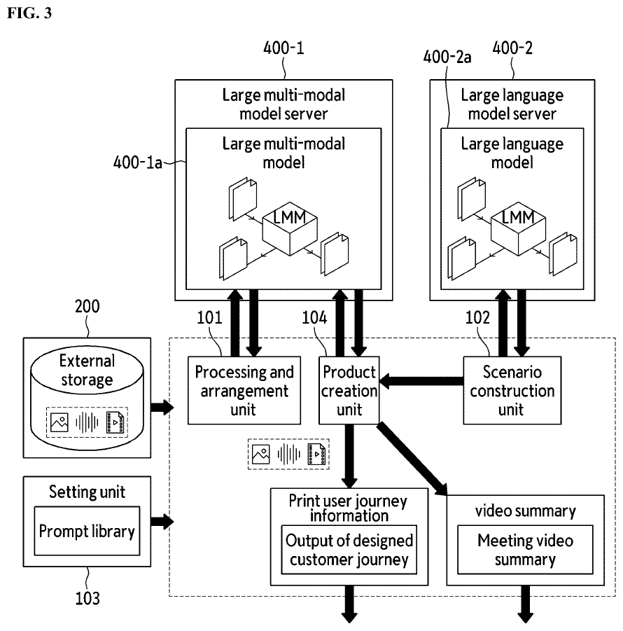

Hereinafter, an operation that may be performed by each of the components illustrated in FIG. 2 will be described with reference to FIGS. 2 to 3.

Referring to FIG. 3, the system 100 for automatically creating the contents according to an embodiment of the disclosure may include a processing and arrangement unit 101, a scenario construction unit 102, a setting unit 103, and a product creation unit 104.

The processing and arrangement unit 101 of the automatic contents creation system 100 according to an embodiment of the present disclosure may transmit the contents set composed of the plurality of contents acquired from external storage 200 to a large multi-modal model server 400-1 as one of artificial neural network servers 400 to the acquire semantic information of the contents set from a large multi-modal model 400-1a.

In some embodiments of the present disclosure, the contents set may be a contents set uploaded by the user terminal 300 to the external storage 200.

In some further embodiments of the present disclosure, the contents set may be acquired by the automatic contents creation system 100 from the user terminal 300.

In some further embodiments of the present disclosure, the semantic information of the contents set may be topic information of the contents set.

For example, the semantic information of the contents set may be information indicating that the contents set is related to a particular conference record.

In another example, the semantic information of the contents set may be information indicating that the contents set is related to a record of a particular wedding.

The processing and arrangement unit 101 of the automatic contents creation system 100 according to another embodiment of the present disclosure may determine one of a plurality of output contents types using the semantic information on the acquired contents set.

In some embodiments of the present disclosure, the plurality of output contents types may include a meeting minutes, a summary video, a user journey map, and a summary document.

The processing and arrangement unit 101 of the automatic contents creation system 100 according to another embodiment of the present disclosure may transmit information on the determined output contents type to the setting unit 103, and the setting unit 103 may automatically create a prompt corresponding to the determined output contents type.

In some embodiments of the present disclosure, the prompt may be any one of a plurality of prompts of a previously existing prompt library.

The product creation unit 104 of the automatic contents creation system 100 according to another embodiment of the present disclosure may input the automatically created prompt and at least some of the plurality of contents to the large multi-modal model to acquire output contents related to the plurality of contents.

In some embodiments of the present disclosure, the processing and arrangement unit 101 may acquire semantic information of each of the plurality of contents from the large multi-modal model 400-1a. In addition, the semantic information of each of the plurality of acquired contents is transmitted to the scenario construction unit 102, and the scenario construction unit 102 inputs the acquired semantic information of each of the plurality of contents to the large language model server 400-2 that is one of the artificial neural network servers 400, thereby acquiring scenario information on the plurality of contents created by the large language model 400-2a based on the semantic information of each of the plurality of contents.

In some further embodiments of the present disclosure, the scenario information may refer to an output of a result of sequentially grasping the content of the plurality of contents.

For example, when the plurality of contents are related to a first meeting record, the scenario information corresponding to the first meeting record may include a summary of utterances of a plurality of speakers related to a first agenda of the first meeting, a summary of utterances of a plurality of speakers related to a second agenda thereof, and solution information derived on the first agenda and the second agenda.

In another example, when the plurality of contents are composed of a plurality of images related to different screens displayed on the user terminal 300 according to a user experience (UX) design of a first service, the scenario information corresponding to the plurality of images may include action information of a user corresponding to each of the plurality of images. This will be described in detail later.

In some further embodiments of the present disclosure, the scenario construction unit 102 may transmit scenario information on the acquired plurality of contents to the product creation unit 104, and the product creation unit 104 may transmit the scenario information to the large multi-modal model server 400-1 to acquire output contents related to the plurality of contents from the large multi-modal model 400-1a.

FIG. 3 illustrates that the large multi-modal model server 400-1 and the large language model server 400-2 which belong to the artificial neural network server 400 are separate servers. However, the present disclosure is not limited thereto. In some further embodiments of the present disclosure, the large multi-modal model server 400-1 and the large language model server 400-2 may be embodied as the same server.

A configuration and an operation of the automatic contents creation system 100 and the example environment to which the automatic contents creation system 100 may be applied have been described with reference to FIGS. 2 to 3. It may be understood that the system 100 for automatically creating contents and the user terminal 300 operate according to a server-client model. However, in some embodiments, the system may be configured in a client stand-alone manner without the need for a server. In this case, it may be understood that the operation performed by the automatic contents creation system 100 is performed by the user terminal 300.

The components included in the example environment to which the automatic contents creation system 100 may be applied and the operations that the components may perform have been described with reference to FIGS. 2 to 3. It should be understood that the embodiments described above are examples and are not-limiting in all aspects. In addition, the configuration and the operation of the automatic contents creation system 100 according to the present embodiment may be supplemented via some embodiments as described below.

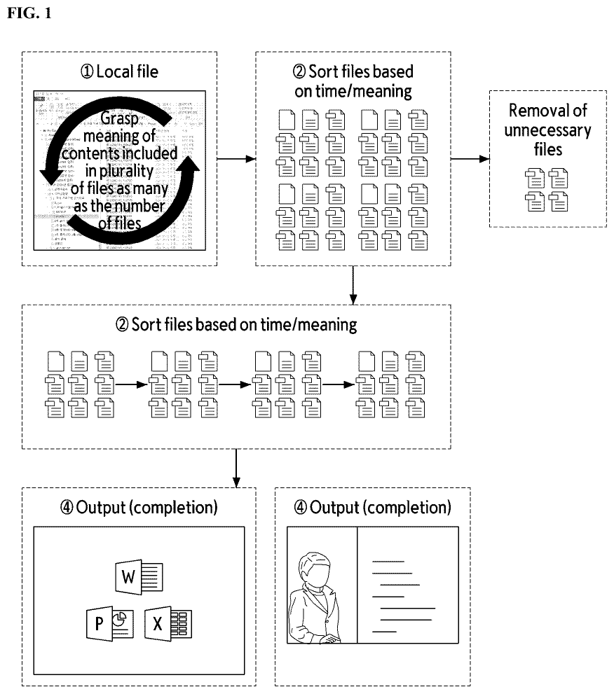

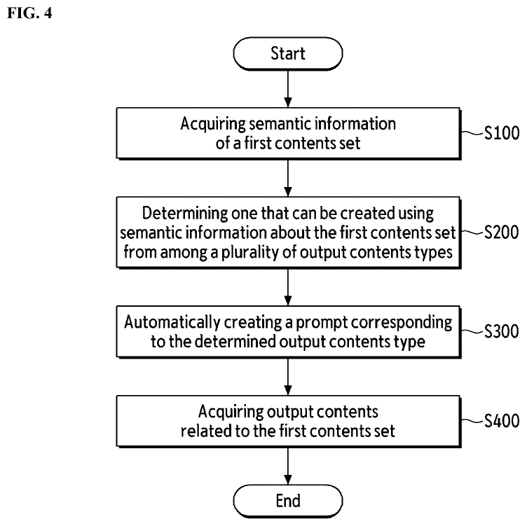

Hereinafter, a method for automatically creating contents according to another embodiment of the present disclosure will be described with reference to FIGS. 4 to 15. It may be understood that the steps to be described below in some flowcharts are performed by the automatic contents creation system 100 as described with reference to FIG. 1 unless otherwise stated. In addition, it is obvious that the technical idea that may be understood in the embodiment as described above with reference to FIGS. 2 to 3 may be applied to the method for automatically creating contents according to the present embodiment.

In step S100, the automatic contents creation system 100 may acquire semantic information about a first contents set including a plurality of contents.

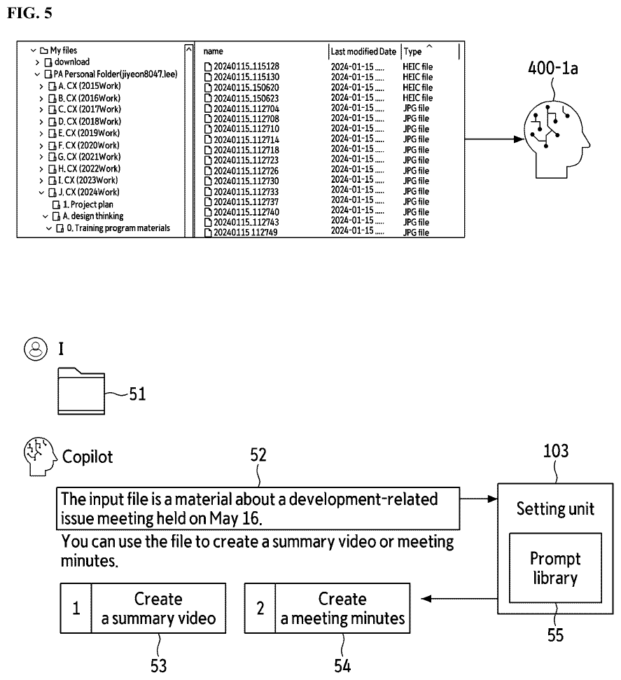

In some embodiments related to step S100, referring to FIG. 5, the automatic contents creation system 100 may input a first contents set 51 to the large multi-modal model 400-1a, thereby acquiring topic information 52 of the first contents set 51 from the large multi-modal model 400-1a.

In step S200, the automatic contents creation system 100 may determine one that can be created using semantic information about the first contents set from among the plurality of output contents types. For example, the automatic contents creation system 100 may determine that the meeting minutes can be created using the first contents set, based on the semantic information about the first contents set.

In some embodiments related to step S200, referring to FIG. 5, when it is determined that the topic information 52 of the first contents set 51 corresponds to the summary video and the meeting minutes, the automatic contents creation system 100 may display a prompt selection button 53 of the summary video and a prompt selection button 54 of the meeting minutes. This will be described in detail later.

In step S300, the automatic contents creation system 100 may automatically create a prompt corresponding to the determined output contents type. For example, when it is determined to create the meeting minutes using the first contents set, the system 100 for automatically creating contents may automatically create a prompt corresponding to the meeting minutes.

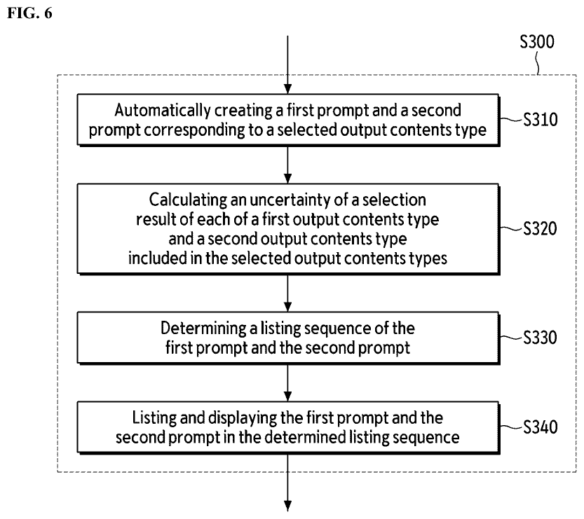

Hereinafter, some embodiments related to step S300 will be described with reference to FIGS. 6 to 9.

In step S310 illustrated in FIG. 6, the system 100 for automatically creating contents may automatically create a first prompt and a second prompt corresponding to the determined output contents type.

For example, referring to FIG. 5, when the topic information 52 on the first contents set 51 corresponds to the output contents type of the summary video and the output contents type of the meeting minutes, the system 100 for automatically creating contents may select the prompt of the summary video and the prompt of the meeting minutes from the prompt library 55. However, in some further embodiments, the prompt of the summary video and the prompt of the meeting minutes may be automatically created by the setting unit 103 of the system 100 for automatically creating contents.

In step S320, the automatic contents creation system 100 may calculate an uncertainty of the determination result of each of the first output contents type and the second output contents type included in the determined output contents type.

In some embodiments related to step S320, the automatic contents creation system 100 may determine that output contents corresponding to each of the output contents type of the summary video and the output contents type of the meeting minutes can be created using the first contents set 51, based on the topic information 52 about the first contents set 51, and may calculate uncertainty information 71 on each of the determination results.

In step S330, the automatic contents creation system 100 may determine a listing sequence of the first prompt corresponding to the first output contents type and the second prompt corresponding to the second output contents type, based on the uncertainty information of the determination result on each of the first output contents type and the second output contents type calculated in step S320.

In some further embodiments related to step S330, the automatic contents creation system 100 may determine a listing sequence in which the prompt selection button 53 of the summary video has a higher priority than the prompt selection button 54 of the meeting minutes, based on a determination that the uncertainty of the determination result that the output contents of the output contents type of the summary video is able to be created using the first contents set 51 is lower than the uncertainty of the determination result that the output contents of the output contents type of the meeting minutes is able to be created using the first contents set 51.

In step S340, the automatic contents creation system 100 may list and display the first prompt and the second prompt according to the determined listing sequence.

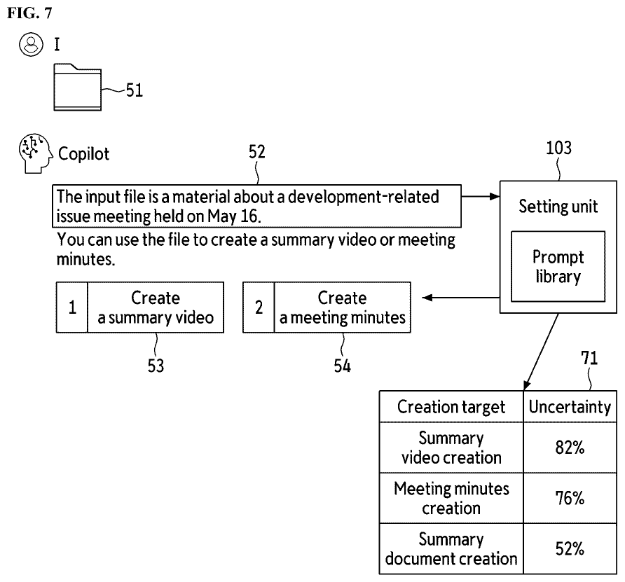

In some embodiments related to the step S340, referring to FIG. 7, the system 100 for automatically creating contents may display a selectable prompt list that allows the prompt selection button 53 of the summary video to be positioned in front of the prompt selection button 54 of the meeting minutes, based on the listing sequence information of the prompt selection button 53 of the summary video and the prompt selection button 54 of the meeting minutes determined in the step S330.

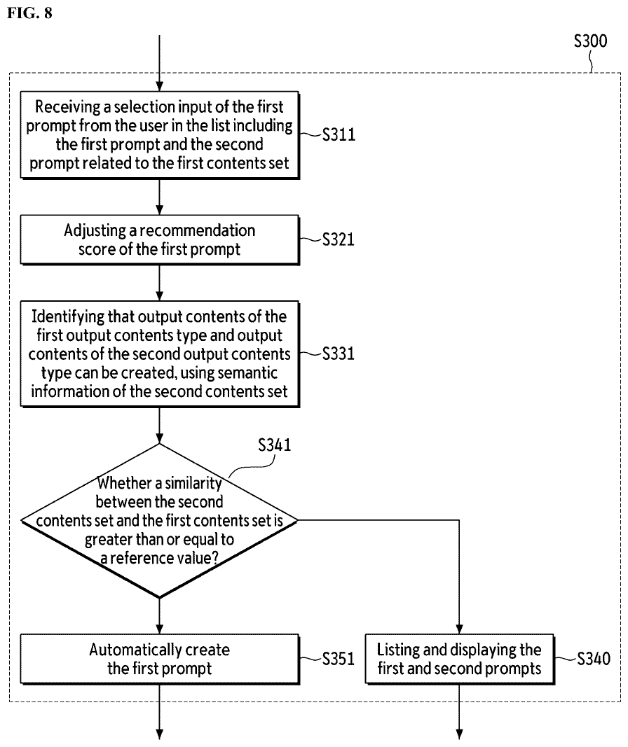

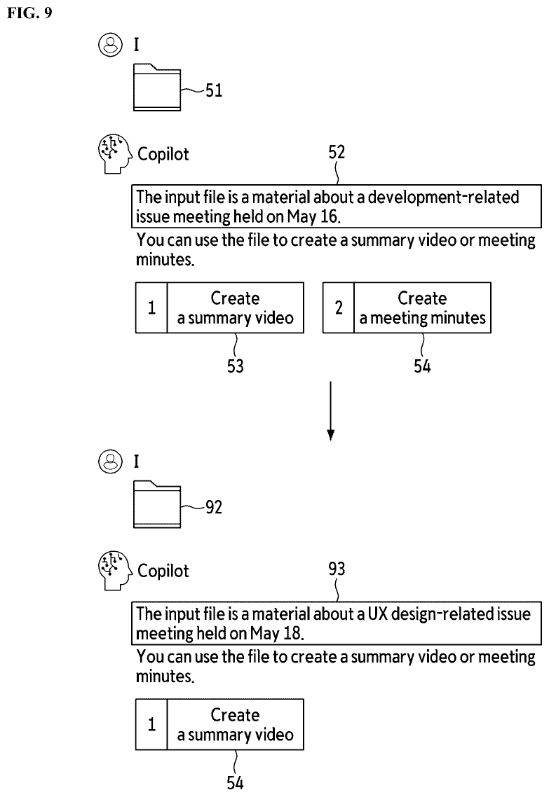

Next, the present disclosure will be described with reference to FIGS. 8 to 9.

In step S311 illustrated in FIG. 8, the system 100 for automatically creating contents may receive a selection input of the first prompt from the user in the list including the first prompt and the second prompt. Further, in step S321, upon receiving the selection input of the first prompt, the system 100 for automatically creating contents may adjust a recommendation score of the first prompt.

In some embodiments related to steps S311 and S321, referring to FIG. 9, upon receiving a selection input 91 of the prompt selection button 54 of the meeting minutes in the list in which the prompt selection button 53 of the summary video and the prompt selection button 54 of the meeting minutes are displayed, the system 100 for automatically creating contents may adjust the recommendation score of the prompt of the meeting minutes.

That is, according to the above-described embodiment, as illustrated in FIG. 7, it is preferable that the type of contents to be created using the first contents set 51 is the summary video. However, the automatic contents creation system 100 may identify that the user prefers the meeting minutes to the summary video as the type of contents created based on the contents having a similar feature to that of the first contents set 51.

In step S331, the automatic contents creation system 100 may identify that output contents of the first output contents type and output contents of the second output contents type can be created using the second contents set, using semantic information of the second contents set different from the first contents set.

In some embodiments related to step S331, referring to FIG. 9, the automatic contents creation system 100 may input the second contents set 92 to the large multi-modal model to acquire topic information 93 about the second contents set 92. Based on a result of analyzing the topic information 93 about the second contents set 92, the automatic contents creation system 100 may identify that the type of output contents that can be created using the second contents set 92 is the output contents type of the summary video and the output contents type of the meeting minutes that are identical with the type of output contents that can be created using the first contents set 51.

In step S341, the automatic contents creation system 100 may calculate a similarity between the second contents set and the first contents set.

In step S351, the system 100 for automatically creating contents may automatically create the first prompt, based on a determination that the similarity between the second contents set and the first contents set is equal to or greater than a reference value and that the recommendation score of the first prompt among the first prompt and the second prompt which are prompts of output contents types that can be created using the second contents set is equal to or greater than a reference value.

In some embodiments related to steps S341 and S351, referring to FIG. 9, when the recommendation score of the prompt of the meeting minutes has been adjusted to the reference value or greater due to the user's selection input 91 of the prompt selection button 54 of the meeting minutes on the first contents set 51, the automatic contents creation system 100 may automatically create only the prompt of the meeting minutes even though the output contents of the output contents type of the meeting minutes and the output contents of the output contents type of the summary video can be created using the second contents set 92.

According to the present embodiment, the system 100 for automatically creating contents may identify the type of output contents that is mainly selected when the user inputs a contents set having a specific topic, and may solve the inconvenience that the user has to unnecessarily perform an additional selection input of one of a plurality of prompt selection buttons.

In step S340, when the similarity between the second contents set and the first contents set is lower than the reference value, the automatic contents creation system 100 may list and display prompts of a plurality of output contents types that can be created using the second contents set. Some embodiments related to step S340 may be clearly understood with reference to some embodiments related to step S340 described above with reference to FIG. 6.

Hereinafter, description will be further made with reference to FIG. 4.

In step S400, the system 100 for automatically creating contents may input the prompt automatically created in step S300 and at least some contents of the first contents set to the large multi-modal model to acquire output contents related to the first contents set.

In some embodiments related to step S400, the automatic contents creation system 100 may input the prompt and at least some contents of the first contents set to a large multi-modal model, thereby acquiring semantic information on each of the contents of the input first contents set.

In addition, the semantic information on each of the contents of the first contents set may be input to the large language model, an output of the large language model may be acquired, and the acquired output of the large language model may be input again to the large multi-modal model to acquire output contents related to the contents of the first contents set.

According to the present embodiment, the system 100 for automatically creating contents may allow the large multi-modal model and the large language model to cooperate with each other in a feature-based manner to achieve an effect of enhancing the quality of output contents related to the first contents set.

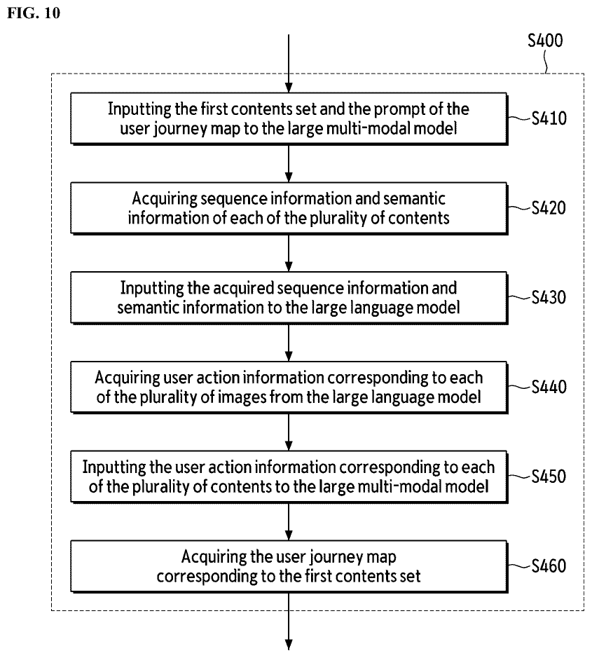

Hereinafter, a method for creating a user journey map which is one of predefined output contents types using the first contents set will be described with reference to FIGS. 10 to 12 to help understand some embodiments related to step S400. However, the embodiments to be described below are only examples for helping understanding of the present disclosure, and it may be understood that the present disclosure is not limited to the method for creating the user journey map using the first contents set.

In step S410 illustrated in FIG. 10, the system 100 for automatically creating contents may input the first contents set and the prompt of the user journey map to the large multi-modal model. In step S420, the system 100 may acquire sequence information and semantic information of each of the plurality of contents included in the first contents set.

In some embodiments related to step S410, the first contents set may be composed of a plurality of images related to different screens displayed on the user terminal according to the UX design of the first service.

In some further embodiments related to step S410, the process of creating the prompt of the user journey map may be clearly understood with reference to steps $100 to S300 described above with reference to FIG. 4.

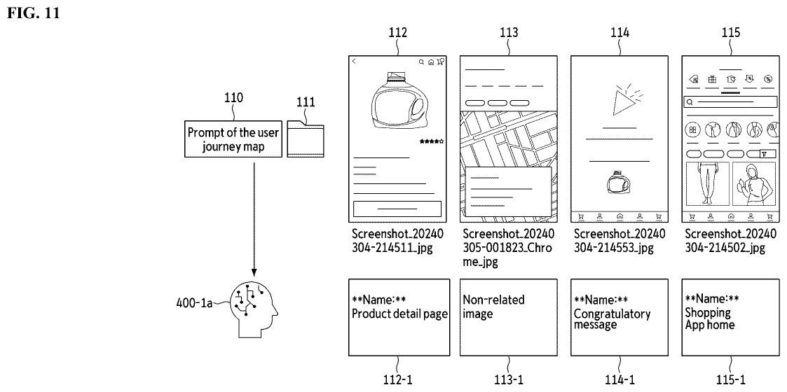

In some embodiments related to step S420, referring to FIG. 11, the automatic contents creation system 100 may input a third contents set 111 including a first image 112, a second image 113, a third image 114, and a fourth image 115 and a prompt 110 of the user journey map to the large multi-modal model 400-1a, and may acquire respective semantic information 112-1, 113-1, 114-1, and 115-1 of the first to fourth images 112, 113, 114, and 115.

In some further embodiments related to step S420, the semantic information 112-1 of the first image 112 may be touch point information corresponding to the first image 112 in the UX design of the first service related to the third contents set 111. For example, as illustrated in FIG. 11, the automatic contents creation system 100 may acquire information indicating that the first image 112 corresponds to a product detail page of the UX design of the first service from the large multi-modal model 400-1a.

In some still further embodiments related to step S420, the semantic information 113-1 of the second image 113 may be information indicating that the second image 113 is not related to the first image 112, the third image 114, and the fourth image 115 included in the third contents set 111. In the above case, the automatic contents creation system 100 may determine that in creating the user journey map related to the third contents set 111, the second image 113 is not used.

In some still further embodiments related to step S420, the sequence information of the third contents set 111 may refer to an order in which the user accesses the first to fourth images 112, 113, 114, and 115 within the UX design of the first service.

For example, the large multi-modal model 400-1a may transmit, to the automatic contents creation system 100, information indicating that the user has accessed the product detail page corresponding to the first image 112 in order to identify a product of the first image 112 in the fourth image 115 that is the home screen of the shopping app, and has accessed the third image 114 appearing as a result of payment of the product of the first image 112.

In step S430, the automatic contents creation system 100 may input the acquired sequence information and semantic information to the large language model, and in step S440, may acquire user action information corresponding to each of the plurality of images from the large language model.

In some further embodiments related to step S440, the user action information may refer to a result acquired by predicting information on an action that the user would have performed on the screen of the first service corresponding to the image by the large language model based on semantic information of the specific image.

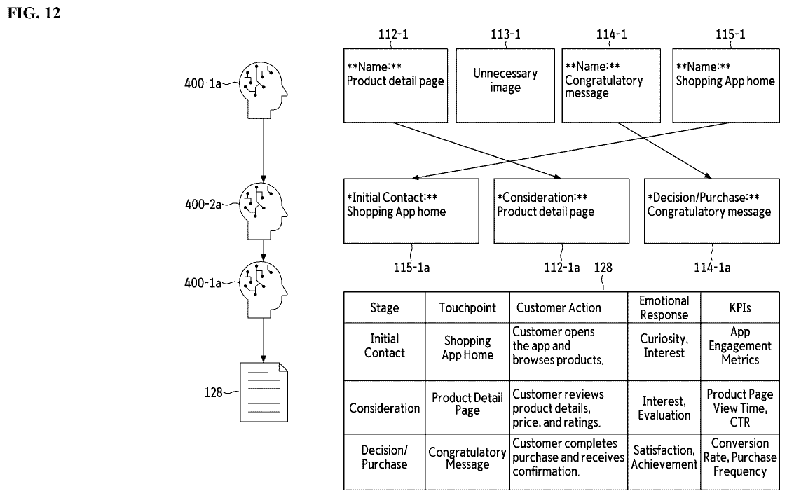

In some embodiments related to steps S430 and S440, referring to FIG. 12, the automatic contents creation system 100 may input the respective semantic information 112-1, 114-1, and 115-1 on the first image 112, the third image 114, and the fourth image 115-1 to the large language model 400-2a, and may acquire respective user action information 115-1a, 112-1a, and 114-1a on the first image 112, the third image 114, and the fourth image 115-1 from the large language model 400-2a.

For example, referring to FIGS. 11 to 12, the fourth image 115 corresponding to the home screen of the shopping app is a first screen of the shopping app. Thus, the large language model 400-2a may determine that the user action information 115-1a in the fourth image 115 is ‘initial contact’, based on the semantic information 115-1 of the fourth image 115.

In another example, referring to FIGS. 11 to 12, the third image 114 corresponding to a congratulatory message is a screen displayed as a result of paying for a specific product. Thus, the large language model 400-2a may determine that the user action information 114-1a in the third image 114 is ‘decision’, based on the semantic information 114-1 of the third image 114.

In still another example, referring to FIGS. 11 to 12, the first image 112 corresponding to the product detail page is a screen accessed by the user to check the details of the specific product, the large language model 400-2a may determine that the user action information 112-1a in the first image 112 is ‘consideration’ based on the semantic information 112-1 of the first image 112.

In step S450, the system 100 for automatically creating contents may input the user action information corresponding to each of the plurality of contents acquired in step S440 to the large multi-modal model, and in step S460, may acquire the user journey map corresponding to the first contents set.

In some embodiments related to steps S450 and S460, referring to FIGS. 11 to 12, the automatic contents creation system 100 may input user the respective action information 115-1a, 112-1a, and 114-1a of the first image 112, the third image 114, and the fourth image 115-1 to the large multi-modal model 400-1a to acquire the user journey map 128 corresponding to the third contents set 111.

In this regard, as illustrated in FIG. 12, the user journey map 128 may include touch point information of the specific service corresponding to each action (stage) performed by the user on the specific service, emotional information of the user at each touch point, and the like. However, the present disclosure is not limited thereto, and any information that may be included in the conventional user journey map may be included in the user journey map 128 without limitations thereto.

In some further embodiments related to steps S450 and S460, referring to FIG. 12, the user journey map 128 output from the large multi-modal model 400-1a may have one of a document format, a video format, an image format, and a text format.

According to the present embodiment, the system 100 for automatically creating contents may reduce a large amount of economic and time costs wasted to construct the user journey map on the specific service in a conventional manner. Furthermore, it is apparent that the present embodiment may provide details of a reference used for creating the prompt for allowing the generative AI to create the user journey map, and a method for cooperating the large multi-modal model with the large language model.

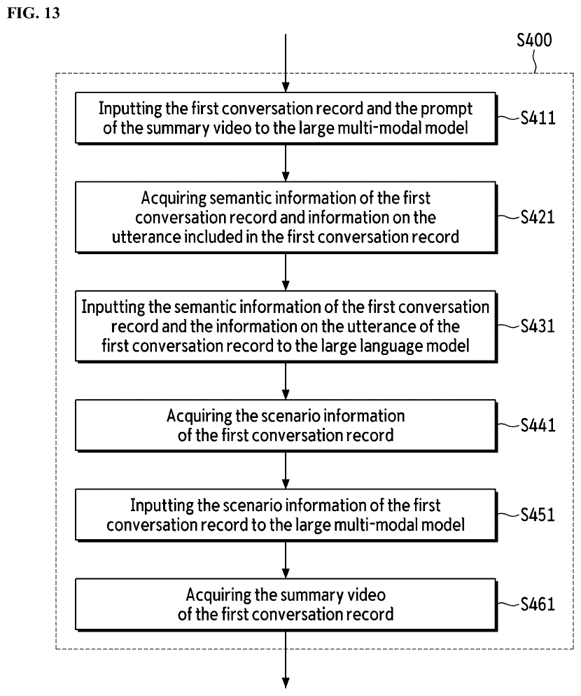

Hereinafter, in order to help understanding of step S400 described above with reference to FIG. 4, a case where the output contents type determined in step S200 is the summary video will be described with reference to FIGS. 13 to 15.

In step S411, the system 100 for automatically creating contents may input the first conversation record and the prompt of the summary video to the large multi-modal model.

The operation of the large multi-modal model to be described in embodiments as set forth below may be performed by the large multi-modal model based on instructions included in the prompt of the summary video.

In step S421, the automatic contents creation system 100 may acquire semantic information of the first conversation record and information on the utterance included in the first conversation record from the large multi-modal model as a result of step S411.

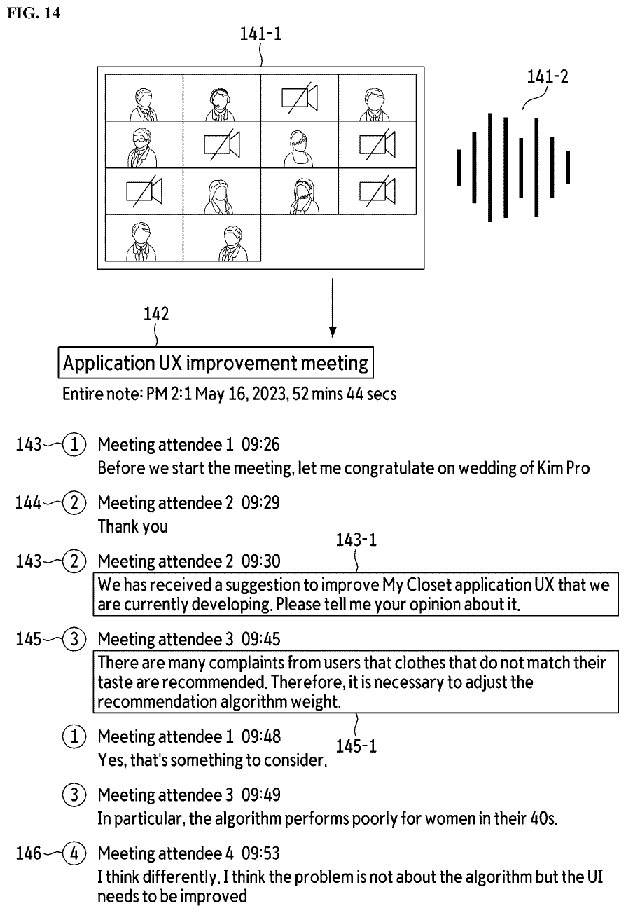

In some embodiments related to step S421, referring to FIG. 14, the automatic contents creation system 100 may input a first conversation record 141-1 of the image format or a first conversation record 141-2 of the audio format to the large multi-modal model, and may acquire semantic information of the first conversation record and information on the utterance included in the first conversation record.

In some further embodiments related to step S421, referring to FIG. 14, the semantic information of the first conversation record may include topic information 142 of the first conversation record.

In some still further embodiments related to step S421, referring to FIG. 14, the information on the utterance included in the first conversation record may mean a result acquired by converting the utterance of each of a first speaker 143, a second speaker 144, a third speaker 145, and a fourth speaker 146 in the first conversation record into a text format and classifying the utterance of the text formation per each speaker.

In step S431, the automatic contents creation system 100 may input the semantic information of the first conversation record and the information on the utterance of the first conversation record acquired in step S421 to the large language model. In addition, in step S441, the scenario information of the first conversation record may be acquired from the large language model. In this regard, the scenario information may be understood by referring to the description of the scenario information described above with reference to FIGS. 2 to 3.

In step S451, the system 100 for automatically creating contents may input the scenario information of the first conversation record acquired in step S441 to the large multi-modal model. In addition, in step S461, the summary video of the first conversation record may be acquired from the large multi-modal model.

In some embodiments related to step S461, the prompt of the summary video input by the automatic contents creation system 100 to the large multi-modal model may include an instruction for instructing the large multi-modal model to create an avatar corresponding to each speaker included in the first conversation record.

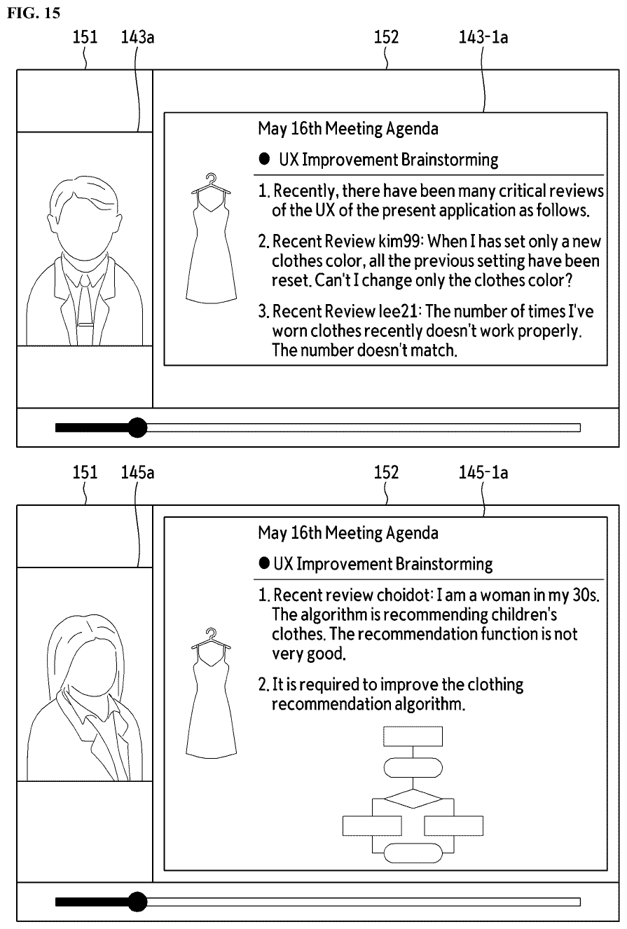

FIG. 15 is an example diagram for illustrating a portion of a summary video of a first conversation record.

In some embodiments related to step S461, referring to FIGS. 14 and 15, the large multi-modal model may create the summary video of the first conversation record so that an avatar 143a of the first speaker 143 is displayed in a first region 151 of the summary video of the first conversation record illustrated in FIG. 15, and the contents 143-1a related to the second utterance 143-1 which is an utterance related to the topic information 142 of the first conversation record of the first speaker 143 is displayed in a second region 152 thereof. The contents 143-1a related to the second utterance 143-1 may be contents previously existing in a contents set including a file of the first conversation record 141-1 in the video format, or may be contents created by the large multi-modal model based on the first conversation record 141-1.

In some further embodiments related to step S461, referring to FIGS. 14 and 15, the large multi-modal model may create the summary video of the first conversation record so that an avatar 145a of the third speaker 145 is displayed in the first region 151 of the summary video of the first conversation record illustrated in FIG. 15 and the contents 145-1a related to the first utterance 145-1 which is an utterance related to the topic information 142 of the first conversation record of the third speaker 145 is displayed in the second region 152 thereof.

In some still further embodiments related to step S461, referring to FIG. 15, the avatar 145a of the third speaker 145 may be automatically created by the large multi-modal model predicting information related to the third speaker 145 based on a plurality of utterances of the third speaker 145 included in the first conversation record 141-1 of the video format or the first conversation record 141-2 of the audio format, but in some further embodiments related to step S461. Alternatively, in some still further embodiments related to step S461, the avatar 145a of the third speaker 145 may be the avatar 145a of the third speaker 145 included in the second conversation record based on a result preset when the third speaker 145 performs a conversation corresponding to the second conversation record of the video format different from the first conversation record.

The method for automatically creating contents according to another embodiment of the present disclosure has been described above with reference to FIGS. 4 to 15. It should be understood that the embodiments as described above are example and are not-limiting in all aspects.

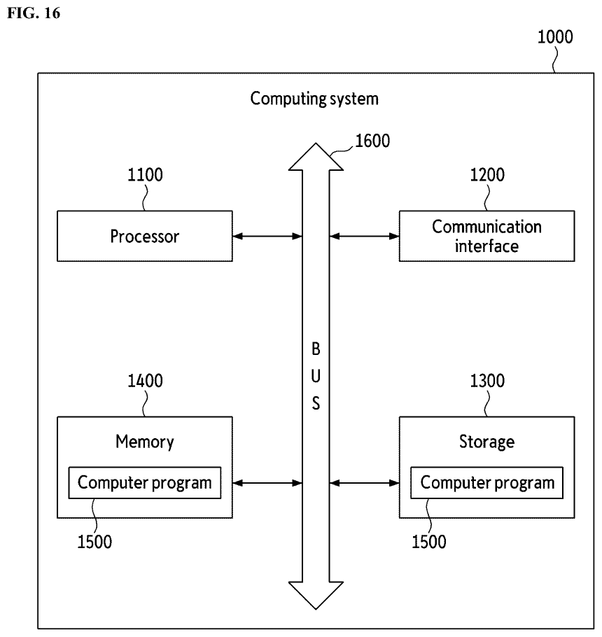

FIG. 16 is a hardware configuration view of an exemplary computing system 1000. Referring to FIG. 14, the computing system 1000 may include at least one processor 1100, a system bus 1600, a communication interface 1200, a memory 1400, which loads a computer program 1500 executed by the processor 1100, and a storage 1300, which stores the computer program 1500.

The processor 1100 may control the overall operations of the components of the computing system 1000. The processor 1100 may perform computations for at least one application or program for executing operations/methods according to some embodiments of the present disclosure. The memory 1400 may store various data, commands, and/or information. The memory 1400 may load the computer program 1500 from the storage 1300 to execute the operations/methods according to some embodiments of the present disclosure. The memory 1400 may be implemented as a volatile memory such as a random access memory (RAM), but the present disclosure is not limited thereto. The bus 1600 may provide communication functionally among the components of the computing system 1000. The communication interface 1200 may support both wired and wireless Internet communication for the computing system 1000. The storage may temporarily store at least one computer program 1500. The computer program 1500 may include one or more instructions that, upon being loaded into the memory 1400, direct the processor 1100 to perform the operations/methods according to some embodiments of the present disclosure. In other words, by executing the loaded instructions, the processor 1100 may perform the operations/methods according to some embodiments of the present disclosure.

In some embodiments, the computing system 1000 may refer to a virtual machine implemented based on cloud technology. For example, the computing system 1000 may be a virtual machine operating on one or more physical servers within a server farm. In this example, at least some of the components of the computing system 1000, i.e., the processor 1100, the memory 1400, and the storage 1300, may be implemented as virtual hardware, and the communication interface 1200 may be implemented as a virtual networking element such as a virtual switch.

A computer program 1500 according to an embodiment may include instructions for performing steps of acquiring semantic information on a contents set composed of a plurality of contents, and inputting a prompt automatically created using the semantic information on the contents set and at least some of the plurality of contents into the large multi-modal model to acquire output contents related to the plurality of contents.

Although operations are shown in a specific order in the drawings, it should not be understood that desired results may be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. An automatic contents creation system comprising:
one or more processors; and
a memory storing therein a computer program executed by the one or more processors,
wherein the computer program includes instructions for:
acquiring semantic information on a contents set composed of a plurality of contents; and
inputting a prompt automatically created using the semantic information on the contents set and at least some of the plurality of contents into a large multi-modal model to acquire output contents related to the plurality of contents.

2. The automatic contents creation system of claim 1, wherein the acquiring of the output contents related to the plurality of contents includes:
selecting one of a plurality of output contents types as an output contents type of the output contents related to the plurality of contents, using the semantic information on the contents set;
automatically creating a prompt corresponding to the selected output contents type; and
inputting the automatically created prompt and at least some of the plurality of contents into the large multi-modal model to acquire the output contents related to the plurality of contents.

3. The automatic contents creation system of claim 2, wherein the output contents type includes a meeting minutes, a summary video, a user journey map, and a summary document.

4. The automatic contents creation system of claim 2, wherein the automatically creating of the prompt corresponding to the selected output contents type includes selecting the prompt corresponding to the selected output contents type from a prompt library.

5. The automatic contents creation system of claim 2, wherein the automatically creating of the prompt corresponding to the selected output contents type further includes:
automatically creating a first prompt and a second prompt corresponding to the selected output contents type when a number of the selected output contents types is at least two;
calculating an uncertainty of a selection result of each of a first output contents type and a second output contents type included in the selected output contents types;
determining a listing sequence of the first prompt and the second prompt, based on the uncertainty of the selection result of each of the first output contents type and the second output contents type; and
listing and displaying the first prompt and the second prompt in the determined listing sequence.

6. The automatic contents creation system of claim 5, wherein the automatically creating of the prompt corresponding to the selected output contents type further includes:
receiving, from a user, a selection input of the first prompt in a list in which the first prompt and the second prompt are displayed;
adjusting a recommendation score of the first prompt;
identifying that output contents of the first output contents type and output contents of the second output contents type can be created using the second contents set, based on semantic information of a second contents set different from the contents set; and
automatically creating the first prompt when the semantic information of the second contents set and the semantic information of the contents set has a similarity greater than or equal to a reference value.

7. The automatic contents creation system of claim 1, wherein the acquiring of the semantic information on the contents set composed of the plurality of contents includes inputting the contents set into the large multi-modal model to acquire the semantic information on the contents set.

8. The automatic contents creation system of claim 1, wherein the acquiring of the output contents related to the plurality of contents includes:
inputting the prompt and at least some of the plurality of contents into the large multi-modal model to acquire semantic information on each of the input plurality of contents;
inputting the semantic information on each of the input plurality of contents to a large language model, and acquiring an output of the large language model; and
inputting the output of the large language model to the large multi-modal model to acquire the output contents related to the plurality of contents.

9. The automatic contents creation system of claim 8, wherein the plurality of contents are composed of a plurality of images related to different screens displayed on a user terminal according to a user experience (UX) design of a first service,
wherein the output contents related to the plurality of contents is a journey map of the UX design.

10. The automatic contents creation system of claim 9, wherein the acquiring of the output contents related to the plurality of contents includes:
inputting the plurality of contents and a third prompt created based on the plurality of contents to the large multi-modal model to acquire sequence information of each of the plurality of contents and semantic information of each of the plurality of contents;
inputting the sequence information of each of the plurality of contents and the semantic information of each of the plurality of contents to the large language model to acquire user action information corresponding to each of the plurality of contents; and
inputting the user action information corresponding to each of the plurality of contents to the large multi-modal model to acquire the journey map of the UX design.

11. The automatic contents creation system of claim 1, wherein the plurality of contents are related to a first conversation record, wherein the first conversation record includes an utterance of a first speaker and an utterance of a second speaker,
wherein the computer program further includes an instruction for creating a fourth prompt instructing to create a summary video of the plurality of contents using the plurality of contents,
wherein the fourth prompt includes instructions to instruct the large multi-modal model to:
determine a topic of the first conversation record, based on the plurality of contents;
extract the utterance of the first speaker corresponding to the topic of the first conversation record;
create an avatar of the first speaker; and
display the avatar of the first speaker in a first region of a scene of a summary video of the plurality of contents in which a first utterance of the first speaker is represented; and
display contents related to the first utterance in a second region thereof.

12. An automatic contents creation method performed by a computing system, the method comprising:
acquiring semantic information on a contents set composed of a plurality of contents; and
inputting a prompt automatically created using the semantic information on the contents set and at least some of the plurality of contents into a large multi-modal model to acquire output contents related to the plurality of contents.

13. The automatic contents creation method of claim 12, wherein the acquiring of the output contents related to the plurality of contents includes:
selecting one of a plurality of output contents types as an output contents type of the output contents related to the plurality of contents, using the semantic information on the contents set;
automatically creating a prompt corresponding to the selected output contents type; and
inputting the automatically created prompt and at least some of the plurality of contents into the large multi-modal model to acquire the output contents related to the plurality of contents.

14. The automatic contents creation method of claim 12, wherein the acquiring of the semantic information on the contents set composed of the plurality of contents includes inputting the contents set into the large multi-modal model to acquire the semantic information on the contents set.

15. The automatic contents creation method of claim 12, wherein the acquiring of the output contents related to the plurality of contents includes:
inputting the prompt and at least some of the plurality of contents into the large multi-modal model to acquire semantic information on each of the input plurality of contents;
inputting the semantic information on each of the input plurality of contents to a large language model, and acquiring an output of the large language model; and
inputting the output of the large language model to the large multi-modal model to acquire the output contents related to the plurality of contents.

16. The automatic contents creation method of claim 15, wherein the plurality of contents are composed of a plurality of images related to different screens displayed on a user terminal according to a user experience (UX) design of a first service,
wherein the output contents related to the plurality of contents is a journey map of the UX design.

17. The automatic contents creation method of claim 16, wherein the acquiring of the output contents related to the plurality of contents includes:
inputting the plurality of contents and a third prompt created based on the plurality of contents to the large multi-modal model to acquire sequence information of each of the plurality of contents and semantic information of each of the plurality of contents;
inputting the sequence information of each of the plurality of contents and the semantic information of each of the plurality of contents to the large language model to acquire user action information corresponding to each of the plurality of contents; and
inputting the user action information corresponding to each of the plurality of contents to the large multi-modal model to acquire the journey map of the UX design.

18. The automatic contents creation method of claim 15, wherein the plurality of contents are related to a first conversation record, wherein the first conversation record includes an utterance of a first speaker and an utterance of a second speaker,
wherein the method further comprises creating a fourth prompt instructing to create a summary video of the plurality of contents using the plurality of contents,
wherein the fourth prompt includes instructions to instruct the large multi-modal model to:
determine a topic of the first conversation record, based on the plurality of contents;
extract the utterance of the first speaker corresponding to the topic of the first conversation record;
create an avatar of the first speaker; and
display the avatar of the first speaker in a first region of a scene of a summary video of the plurality of contents in which a first utterance of the first speaker is represented; and
display contents related to the first utterance in a second region thereof.

19. The automatic contents creation method of claim 13, wherein the automatically creating of the prompt corresponding to the selected output contents type includes selecting the prompt corresponding to the selected output contents type from a prompt library.

20. The automatic contents creation method of claim 13, wherein the automatically creating of the prompt corresponding to the selected output contents type further includes:
automatically creating a first prompt and a second prompt corresponding to the selected output contents type when a number of the selected output contents types is at least two;
calculating an uncertainty of a selection result of each of a first output contents type and a second output contents type included in the selected output contents types;
determining a listing sequence of the first prompt and the second prompt, based on the uncertainty of the selection result of each of the first output contents type and the second output contents type; and
listing and displaying the first prompt and the second prompt in the determined listing sequence.
